(19) United States
(12) Patent Application Publication
(10) Pub. No.: US 2024/0386238 A1
(43) Pub. Date: Nov. 21, 2024

(54) SCATTERING VISION TRANSFORMER

(71) Applicant: Microsoft Technology Licensing, LLC, Redmond, WA (US)

(72) Inventors: Vijay Srinivas AGNEESWARAN, Bangalore (IN); Badri Narayana PATRO, Bangalore (IN)

(21) Appl. No.: 18/325,696

(22) Filed: May 30, 2023

Related U.S. Application Data
(60) Provisional application No. 63/502,688, filed on May 17, 2023.

(51) Int. Cl. G06N 3/04

(52) U.S. Cl. CPC G06N 3/04

(57) ABSTRACT

A vision transformer is provided featuring improved computational efficiency. A plurality of image vectors corresponding to an input image is provided to a sequence of neural network layers configured to generate an image classification. The neural network layers comprise at least one scatter layer coupled to at least one attention layer, the scatter layer configured to receive the plurality of image patch vectors and to generate low-frequency tokens and high-frequency tokens by applying a dual-tree complex wavelet transform and applying tensor and Einstein mixing to each set of tokens, respectively. The tokens are thereafter transformed back to the physical domain by an inverse scatter network, provided to a multi-layer perceptron (MLP) layer which in turn provides an output to the at least one attention layer that includes multi-head self-attention and MLP layers further coupled to a classifier head configured to generate a classification of the input image.

### CROSS REFERENCE TO RELATED APPLICATIONS

This application claims priority to U.S. Provisional Application No. 63/502,688, filed on May 17, 2023, entitled “SCATTERING VISION TRANSFORMER,” which is incorporated by reference herein in its entirety.

### BACKGROUND

A transformer is a type of deep learning model distinguished by its adoption of self-attention, differentially weighting the significance of each part of the input (which includes the recursive output) data. Transformers originated in the natural language processing (NLP) domain and have gone on to revolutionize NLP in the form of deep neural networks (DNNs), which are sometimes referred to as large language models (LLMs). Such LLMs may be used for question-answering, machine translation, and sentiment analysis tasks in the NLP domain. The transformer concepts have subsequently been extended to other domains such as computer vision, speech, video processing as well as climate and weather prediction. A vision transformer (ViT) is a type of transformer that is targeted at vision processing tasks such as image recognition.

Transformers in the computer vision domain have, like their NLP brethren, typically employed encoders based on multi-headed self-attention for classifying images into categories. Such transformers operate much like LLMs where instead of breaking sentences into tokens (i.e., words) and feeding such tokens to the transformer, images are instead segmented into patches that are used as tokens. Although such vision transformers have achieved state-of-the-art accuracy in image classification tasks, the computational complexity of the self-attention module increases quadratically as image size increases.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and non-transitory computer readable media are provided for greater computational efficiency in image classification tasks. In an aspect, a plurality of image patch vectors corresponding to an input image is provided to a sequence of neural network layers configured to generate an image classification. In one aspect, the sequence of neural network layers comprises at least one scatter layer configured to receive the plurality of image patch vectors and to process the plurality of image patch vectors to generate a first scatter output, at least one attention layer configured to receive the first scatter output and to process the first scatter output to generate an attention output, and a classifier head layer configured to receive the attention output and to process the first scatter output to generate the classification of the input image.

In a further aspect, the at least one scatter layer comprises a scatter network layer configured to receive the plurality of image patch vectors and to generate low-frequency tokens and high-frequency tokens by applying a dual-tree complex wavelet transform, a token mixing layer configured to mix the low-frequency tokens with a first set of trainable weights to generate a low-frequency representation and to mix the high-frequency tokens with a second set of trainable weights to generate a high-frequency representation, an inverse scatter network layer configured to combine the low-frequency representation and the high-frequency representation by applying an inverse dual-tree complex wavelet transform to generate a combined output, and a multi-layer perceptron layer configured to receive the combined output and process the combined output to generate the first scatter output.

In another example aspect, the token mixing layer is configured to mix the low frequency tokens with the first set of trainable weights by performing tensor mixing.

In another example aspect, the token mixing layer is configured to mix the high frequency tokens with the second set of trainable weights by performing Einstein mixing.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 depicts an example artificial neuron suitable for use in a deep neural network (“DNN”), according to an embodiment.

FIG. 2 depicts an example DNN composed of artificial neurons, according to an embodiment.

FIG. 3 depicts a block diagram view of a scattering vision transformer model, according to an embodiment.

FIG. 4 depicts a block diagram view of an example scatter layer of a scattering vision transformer model, according to an embodiment.

FIG. 5 depicts a block diagram view of an example attention layer of a scattering vision transformer model, according to an embodiment.

FIGS. 6a-6c depict flowcharts of example methods for generating an image classification of an input image, according to an embodiment.

FIG. 7 is a block diagram of an example computer system in which embodiments may be implemented.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

A deep neural network (DNN) is a type of artificial neural network (ANN) with multiple layers between the input and output layers, and that conceptually is comprised of artificial neurons. Recently, the trend has been towards DNNs with ever increasing size, and current DNNs may be characterized by millions of parameters each represented in any data format (e.g., int8, uint8, float32, etc.). Training and various inference tasks given to such DNNs can be challenging since it may be difficult or impossible to achieve scalable solutions. For example, the multi-headed self-attention modules used in recent vision transformer models offer excellent classification results but at the cost of O(N²) computational complexity (i.e., run time increases quadratically with increases in image resolution.

One way to address the computational complexity of attention-based transformers is to replace the attention mechanism with a multi-layer perceptron (MLP) based mixer layer. However, MLP mixers have difficulty capturing adequate spatial information. Other approaches use a pooling operation in place of the attention layer. However, the pooling operation has the disadvantage of being not invertible and leading to possible loss of information.

Embodiments disclosed herein address these and other shortcomings of available vision transformers by using a scatter network for token mixing in place of the initial self-attention layers of conventional vision transformers, thereby creating scattering vision transformers. A scatter network enables embodiments the ability to capture orientational features of an image such as lines and edge while also dramatically improving computational complexity. The scattering vision transformer embodiments disclosed herein may be implemented as a deep neural network (DNN) configured to perform image classification.

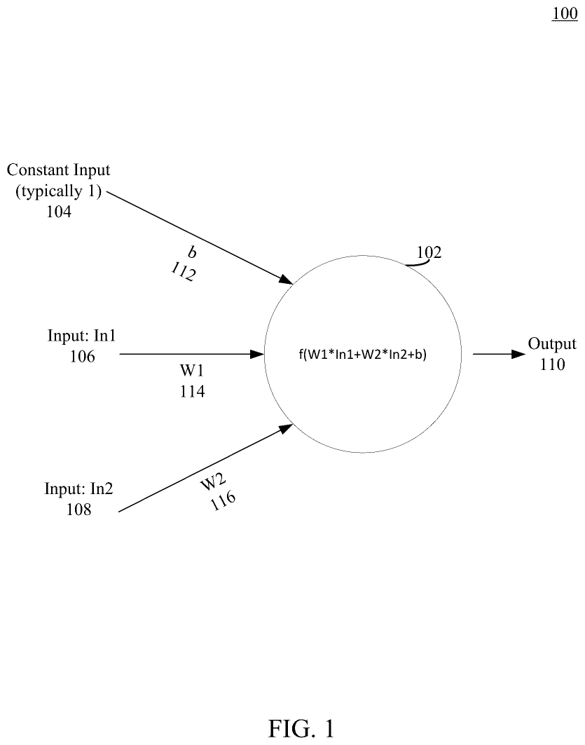

DNNs and other types of neural networks are constructed using multiple layers of artificial neurons. For example, FIG. 1 depicts an example artificial neuron 100 suitable for use in a DNN, according to an embodiment. Neuron 100 includes an activation function 102, a constant input CI 104, an input In1 106, an input In2 108 and output 110. Neuron 100 of FIG. 1 is merely exemplary, and other structural or operational embodiments will be apparent to persons skilled in the relevant art(s) based on the description neuron 100 of FIG. 1, which follows.

Neuron 100 operates by performing activation function 102 on weighted versions of inputs CI 104, In1 106 and In2 108 to produce output 110. Inputs to activation function 102 are weighted according to weights b 112, W1 114 and W2 116. Inputs In1 106 and In2 108 may comprise, for example, normalized or otherwise feature processed data (e.g., images). Activation function 102 is configured to accept a single number (i.e., in this example, the linear combination of weighted inputs) based on all inputs, and to perform a fixed operation. As known by persons skilled in the relevant art(s), such operation may comprise, for example, sigmoid, tan h or rectified linear unit operations. Input CI 104 comprises a constant value (commonly referred to as a ‘bias’) which may typically be set to the value 1, and allows the activation function 502 to include a configurable zero crossing point as known in the relevant art(s).

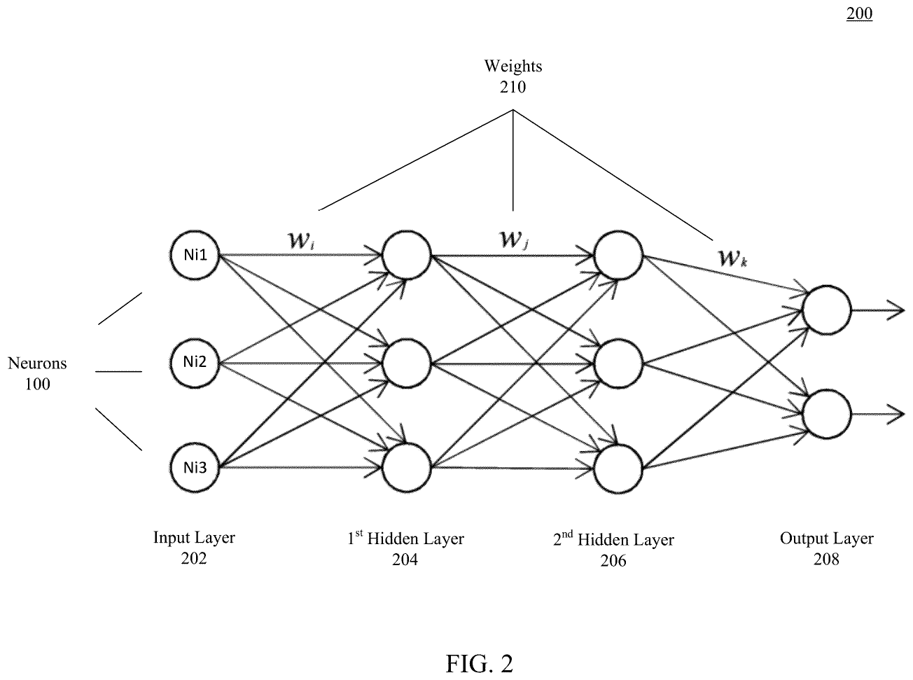

A single neuron generally will accomplish very little, and a useful machine learning model will require the combined computational effort of a large number of neurons working in concert (e.g., ResNet50 with ˜94,000 neurons). For instance, FIG. 2 depicts an example deep neural network (“DNN”) 200 composed of a plurality of neurons 100, according to an embodiment. DNN 200 includes neurons 100 assembled in layers and connected in a cascading fashion. Such layers include an input layer 200, a first hidden layer 204, a second hidden layer 206 and an output layer 208. DNN 200 depicts outputs of each layer of neurons being weighted according to weights 210, and thereafter serving as inputs solely to neurons in the next layer. It should be understood, however, that other strategies for interconnection of neurons 100 are possible in other embodiments, and as is known by persons skilled in the relevant art(s).

The neurons 100 of input layer 202 (labeled Ni1, Ni2 and Ni3) each may be configured to accept normalized or otherwise feature engineered or processed data corresponding to sensor data 106 as described above in relation to neuron 100 of FIG. 1. The output of each neuron 100 of input layer 202 is weighted according to the weight of weights 210 that corresponds to a particular output edge, and is thereafter applied as input at each neuron 100 of 1^{st} hidden layer 204. It should be noted that each edge depicted in DNN 200 corresponds to an independent weight, and labeling of such weights for each edge is omitted for the sake of clarity. In the same fashion, the output of each neuron 100 of first hidden layer 204 is weighted according to its corresponding edge weight, and provided as input to a neuron 100 in 2^{nd} hidden layer 206. Finally, the output of each neuron 100 of second hidden layer 206 is weighted and provided to the inputs of the neurons of output layer 208. The output or outputs of the neurons 100 of output layer 208 comprises the output of the model. In the context of the descriptions above, weight matrix 302 of compressed representation 212 is comprised of weights 210. Note, although output layer 208 includes two neurons 100, embodiments may instead include just a single output neuron 100, and therefore but a single discrete output. Note also, that DNN 200 of FIG. 2 depicts a simplified topology, and typically, producing useful inferences from a DNN like DNN 200 typically requires far more layers, and far more neurons per layer. Thus, DNN 200 should be regarded as a simplified example.

Construction of the above described DNN 200 is part of generating a useful machine learning model. The accuracy of the inferences generated by such a DNN require selection of a suitable activation function, and thereafter the each of the weights of the entire model are adjusted to provide accurate output. The process of adjusting such weights is called “training.” Training a DNN, or other type of neural network, requires a collection of training data of known characteristics. For example, where a DNN is intended to predict the probability that an input image of a piece of fruit is an apple or a pear, the training data would comprise many different images of fruit, and typically including not only apples and pears, but also plums, oranges and other types of fruit. Training requires that the image data corresponding to each image is pre-processed according to normalization and/or feature extraction techniques as known to persons skilled in the relevant art(s) to produce input features for the DNN, and such features are thereafter input to the network. In the example above, such features would be input to the neurons of input layer 202.

Thereafter, each neuron 100 of DNN 200 performs their respective activation function operation, the output of each neuron 100 is weighted and fed forward to the next layer and so forth until outputs are generated by output layer 208. The output(s) of the DNN may thereafter be compared to the known or expected value of the output. The output of the DNN may then be compared to the expected value and the difference fed backward through the network to revise the weights contained therein according to a backward propagation algorithm as known to persons skilled in the relevant art(s). With the model including revised weights, the same image features may again be input to the model (e.g., neurons 100 of input layer 202 of DNN 200 described above), and new output generated. Training comprises iterating the model over the body of training data and updating the weights at each iteration. Once the model output achieves sufficient accuracy (or outputs have otherwise converged and weight changes are having little effect), the weights of the model are said to be trained. A trained model may thereafter be used to evaluate arbitrary input data, the nature of which is not known in advance, nor has the model previously considered (e.g., a new picture of a piece of fruit), and output the desired inference (e.g., the probability that the image is that of an apple).

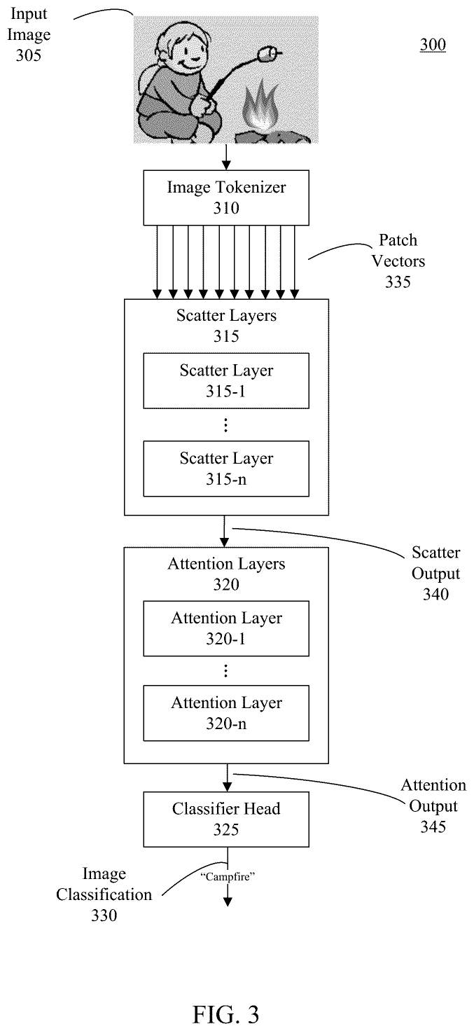

The above described DNN is a general description of aspects of a neural network suitable for use in a scattering vision transformer. Scattering vision transformers may, however, be constructed in various ways. For example, FIG. 3 depicts a block diagram view of a scattering vision transformer 300, according to an embodiment. In FIG. 3, scattering vision transformer 300 includes an image tokenizer 310, a set of scatter layers 315, a set of attention layers 320 and a classifier head 325. Other structural and operational embodiments will be apparent to persons skilled in the relevant art(s) based on the following description regarding scattering vision transformer 300 as depicted in FIG. 3.

Scattering vision transformer 300 is configured to accept input image 305 and to generate image classification 330 in response thereto, in an embodiment. More specifically, suppose that the neural network layers of scattering vision transformer 300 have been suitably trained in a manner similar to that described above. In such an instance, scattering vision transformer 300 may be provided input image 305 which, for the purposes of this description, should be understood to depict a campfire. The processing steps undertaken by scattering vision transformer 300 as described herein below perform operations that permit scattering vision transformer 300 to determine with a high probability that input image 305 does in fact depict a campfire.

Input image 305 is first provided to image tokenizer 310 which operates in the following general manner. First, image tokenizer 310 receives input image 305 typically in the form of a 3-dimensional tensor package that may, for example, comprise a 128×128×3 tensor package that corresponds to a 128×128 pixel image and RBG color space values for each pixel. Image tokenizer 310 thereafter decomposes input image 305 into patches with each patch comprising a sub-image of input image 305. For example, image tokenizer 310 may spatially divide input image 305 along height and width dimensions into 16 tensor packages each sized 32×32×3 wherein each such package comprises a patch.

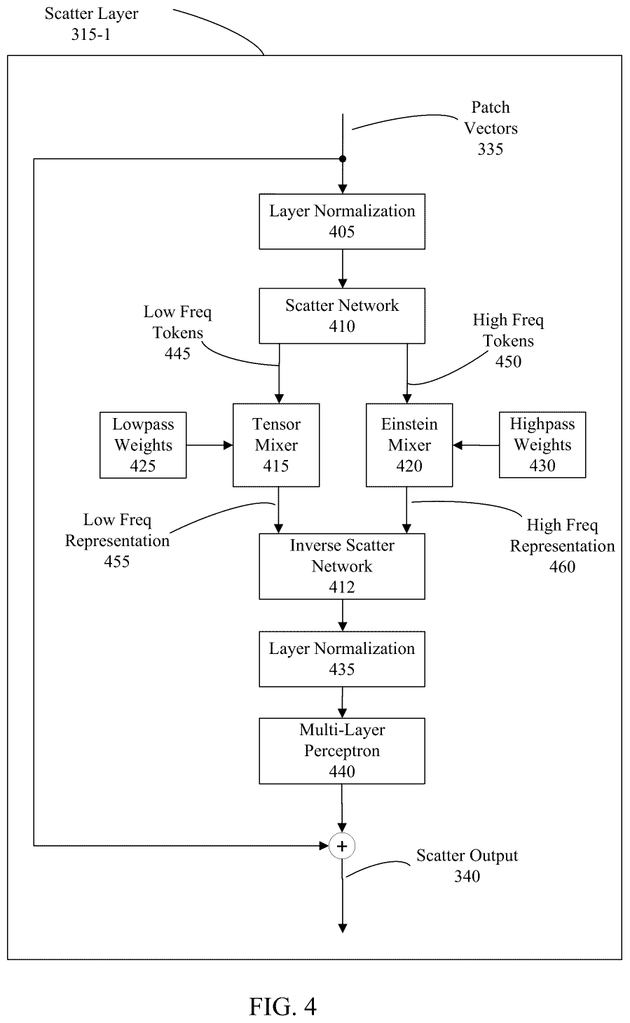

Image tokenizer 310 thereafter linearly projects each tensor package into a vector thereby generating a plurality of image patch vectors. Each such image patch vector is further processed to augment each image patch vector with position embedding which reflects the physical location within input image 305 of the respective patch to which it corresponds. Such embedding permits the model to account for the positional dependencies between the patches, as known in the relevant art(s), with the resulting vectors comprising patch vectors 335 as depicted in scattering vision transformer 300 of FIG. 3. Patch vectors 335 are thereafter passed to scatter layers 315. Operational aspects of scatter layers 315 are described as follows in conjunction with FIG. 4.

FIG. 4 depicts a block diagram view of an example scatter layer 315-1 (as an example scatter layer) of a scattering vision transformer model, according to an embodiment. As shown in FIG. 4, scatter layer 315-1 includes a layer normalization 405, a scatter network 410, a tensor mixer 415, Einstein mixer 420, an inverse scatter network 412, a layer normalization 435 and a multi-layer perceptron 440. Other structural and operational embodiments will be apparent to persons skilled in the relevant art(s) based on the following description regarding scatter layer 315-1 as depicted in FIG. 4.

Each of layer normalization 405 and layer normalization 435 implement, as known in the art, a layer normalization algorithm whereby vectors provided to layer normalization 405 and layer normalization 435 (as well as other layer normalization layers depicted in other figures and as described herein below) are scaled to fit on the interval of [0,1] as known in the art. For example, the maximum vector value may be scaled to be a ‘1’ whereas the minimum vector value is mapped to a ‘0’ with intervening vector values distributed therebetween in a manner a proportional manner as known in the art. Such normalization is performed during training time to reduce training time, and mean and variance statistics are calculated and maintained for later use when performing inference. The normalized vectors are thereafter passed to scatter network 410.

Scatter network 410 implements a dual-tree complex wavelet (DTCW) transform that is used in place of a self-attention module as typically used in prior art vision transformers. At a high level, the use of DTCW transform takes the images from the physical to the frequency domain and is invertible while capturing fine grained information of the image low-pass and high-pass filters. The low-pass component of scatter network 410, depicted as low frequency tokens 445 in FIG. 4, provides the coarse-grained information of input image 305, whereas the high-pass component of scatter network 410, depicted as high frequency tokens 450, provides the fine-grained information of input image 305.

It should be noted that DTCW transforms are different than discrete wavelet transforms (DWTs) such as Haar or Daubechies wavelet transforms which have traditionally been used to decompose images into low and high-frequency components. Unlike DTCW, DWTs do not capture phase information and consequently are not shift-invariant or directionally insensitive to high dimensions. Moreover, DWTs suffer from aliasing wherein high-frequency components can be folded back to lower frequencies during down-sampling which can lead to information loss and signal distortion. DTCW transforms, on the other hand, includes both real and imaginary components to better separate high-frequency components while reducing aliasing thereby improving accuracy. Further, the DTCW transform has better directional sensitivity which makes it easier to detect edges and orientational features of images.

An input image x is filtered using dual-tree complex wavelet x★χλ₁, where λ₁=(j, r), as follows: x★χλ1=x★χ^{a}_{λ1}+ix★χ^{b}_{χ1}. Where χ^{a} and χ^{b} are the real and imaginary components, respectively, of the wavelet. The wavelet filtering signal is computed with translation and thus is not translation invariant. A translation invariant representation may be obtained by applying an L2 non-linearity to the filtered signal.

In embodiments, scatter network 410 implements a parametrized gating mechanism in both low and high-frequency components with six orientations helping to effectively capture the slanted edges in input image 305. Each scatter layer of scatter layers 315 controls the amount of information passed to the next layer by using two sets of learnable weight parameters (depicted as lowpass weights 425 and highpass weights 430 in FIG. 4) to mix with each of low frequency tokens 445 and high frequency tokens 450. In essence, low frequency tokens 445 get multiplied by the learnable weight parameters of lowpass weights 425 to give a filtered output, helping control the amount of information passed. Similarly, high frequency tokens 450 are multiplied by the learnable weight parameters of highpass weights 430. In an embodiment, such multiplication/mixing is performed using tensor multiplication for the low-pass gating network, and Einstein mixing for the high-pass gating network. Each such function is implemented in tensor mixer 415 and Einstein mixer 420, respectively.

Tensor mixer 415 implements tensor mixing by performing tensor multiplication such that input tensors [b, H, W, C] are multiplied by the trainable weight tensors [H, W, C] to yield the filtered frequency domain tensor of the form [b, H, W, C].

Einstein mixing occurs in a channel direction, which splits the channels into blocks of sub-channels. The weights corresponding to the sub-channels are multiplied using Einstein multiplication (using, for example, the Einstein summation einsum( ) function in pytorch). The channels provide depth information, which captures the orientation of the filter components. Thus, embodiments of scattering vision transformer 300 give more emphasis on depth direction to capture fine-grained information more efficiently. Einstein mixing performs, for example, pytorch einsum( ) multiplication whereby weight tensors [C_b, C_d, C_k] are multiplied by image tensors [b, H, W, m, C_b, C_d] to yield the filtered frequency domain tensor of the form [b, H, W, m, C_b, C_k], where ‘m’ is directional orientations. ‘C’ is equal to ‘C_b’ times ‘C_d’.

Low frequency representation 455 and high frequency representation 460 generated by tensor mixer 415 and Einstein mixer 420, respectively, are subsequently provided to inverse scatter network 412 to transform the spectral domain vectors back to the physical domain. Lastly, embodiments of scattering vision transformer 300 leverages multi-layer perceptron 440 as a classifier to compute the appropriate class to which the image belongs.

In embodiments, scatter layers 315 may comprise one or more scatter layers such as scatter layers 315-1 through scatter layers 315-n. For example, scatter layers 315 may comprise two such scatter layers coupled together in sequence with the output of one such layer provided as input to the next such scatter layer. Other configurations are, however, possible in embodiments. For example, embodiments may implement a hierarchical scattering vision transformer wherein instead of a plurality of series connected scatter layers coupled in turn to a plurality of series connected attention layers, embodiments may implement a multi-stage scattering vision transformer. For example, a first stage may comprise two series connected scatter layers coupled an attention layer, wherein the output of the first stage is coupled to a second identical stage, and wherein further stages comprising a plurality of attention layers and/or combination of attention and scatter layers.

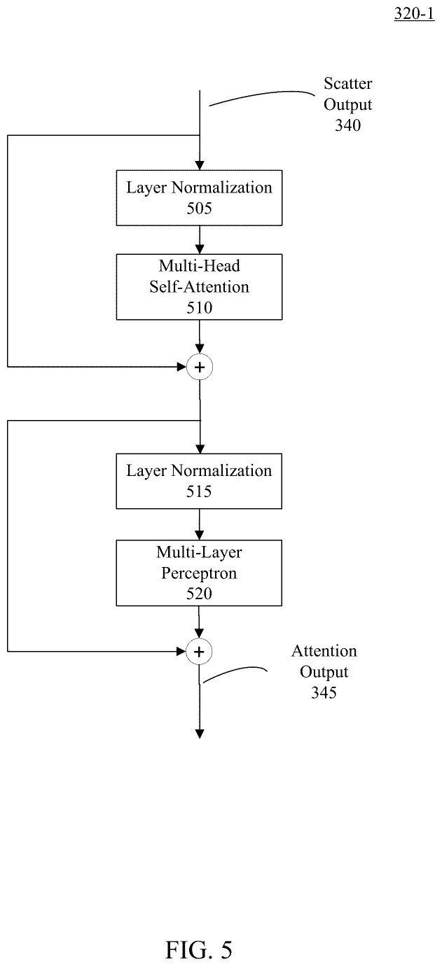

With continued reference to scattering vision transformer 300 of FIG. 3, operational aspects of attention layers 320 of FIG. 3 is described. FIG. 5 depicts a block diagram view of attention layer 320-1 (as an example attention layer) of scattering vision transformer 300 as shown in FIG. 3, according to an embodiment. Attention layer 320-1 includes a layer normalization 505, a multi-head self-attention 510, a layer normalization 515 and a multi-layer perceptron 520. However, other structural and operational embodiments will be apparent to persons skilled in the relevant art(s) based on the following description regarding FIG. 5 and scattering vision transformer 300 of FIG. 3.

Each of layer normalization 505 and layer normalization 515 implement a layer normalization algorithm as described in detail above with respect to layer normalization 405 and layer normalization 435. The output of layer normalization 505 is provided to multi-head self-attention 510.

Multi-head self-attention 510 receives the output from layer normalization 505 and operates in the standard manner of self-attention layers as known in the art. Attention in the deeper layers is retained in the deeper layers so that long-range dependencies can be handled effectively. Multi-head self-attention 510 uses self-attention using the standard key (K), query (Q) and value (V) to compute which image patches are important within the current image patch for image classification. The output from multi-head self-attention 510 is summed with scatter output 340 which is fed forward from the input to layer normalization 505 with the summation provided as input to layer normalization 515. As described above, layer normalization 515 operates in a conventional manner with its output subsequently provided to multi-layer perceptron 520. Multi-layer perceptron 520 comprises a conventional feed-forward neural network using non-linear activation.

Finally, and with continued reference to scattering vision transformer 300 as depicted in FIG. 3, attention output 345 from attention layers 320 is provided to classifier head 325 which operates in a standard manner to compute a plurality of probabilities that input image 305 belongs to particular image classes. For example, suppose that scattering vision transformer 300 was trained using 3 types of images such as, for example, images of campfires, dogs and airplanes. Classifier head 325 is configured to accept attention output 345 and calculate the probability that input image 305 is a campfire, a dog or an airplane. In this example, image classification 330 output from classifier head 325 could comprise the vector [0.95, 0.025 and 0.025] signifying that scattering vision transformer 300 has determined that input image 305 is an image of a campfire with 95% probability, and that there is only a 2.5% chance that input image 305 comprises either a dog or an airplane.

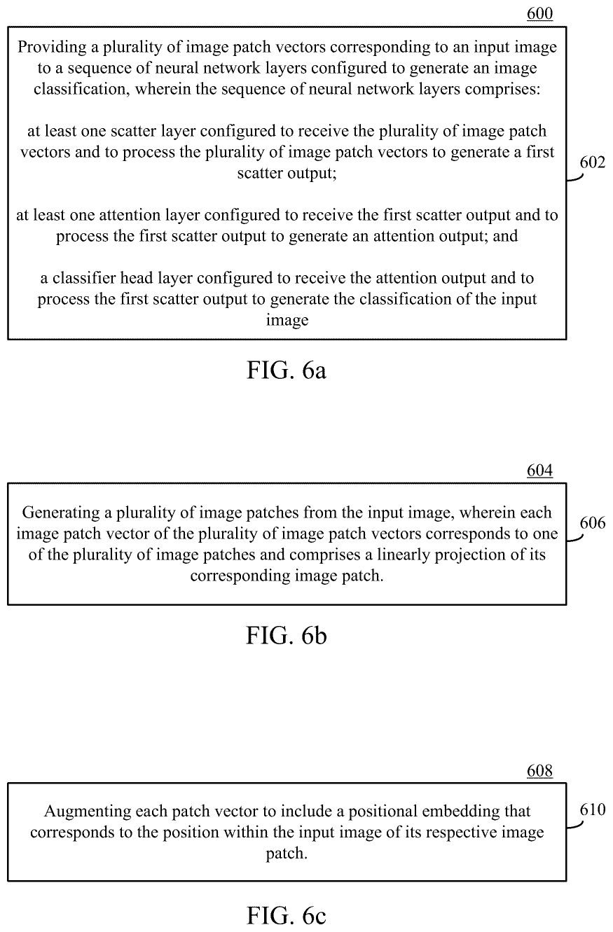

Further operational aspects of scattering vision transformer 300 of FIG. 3 are described as follows in conjunction with FIGS. 6a, 6b and 6c. FIGS. 6a-6c, which depict flowcharts 600, 604, and 608 of methods and refinements thereto for generating an image classification of an input image, according to an embodiment. Flowcharts 600, 604 and 608 are described with reference to FIGS. 3, 4, and 5. However, other structural and operational embodiments will be apparent to persons skilled in the relevant art(s) based on the following description regarding flowcharts 600, 604 and 608 of FIGS. 6a, 6b and 6c and scattering vision transformer 300 of FIG. 3.

Flowchart 600 includes step 602. At step 602, a plurality of image patch vectors corresponding to an input image to is provided to a sequence of neural network layers configured to generate an image classification, wherein the sequence of neural network layers comprises: at least one scatter layer configured to receive the plurality of image patch vectors and to process the plurality of image patch vectors to generate a first scatter output, at least one attention layer configured to receive the first scatter output and to process the first scatter output to generate an attention output, and a classifier head layer configured to receive the attention output and to process the first scatter output to generate the classification of the input image. For example, scattering vision transformer 300 as shown in FIG. 3, and as described above, is configured to accept input image 305, convert input image 305 to patch vectors 335 and provide same to the sequence of neural network layers that comprise scatter layers 315 and attention layers 320, and wherein attention output 345 from attention layers 320 is provided to classifier head 325 to generate image classification 330.

Flowchart 604 includes step 606. At step 606, Generating a plurality of image patches is generated from the input image, wherein each image patch vector of the plurality of image patch vectors corresponds to one of the plurality of image patches and comprises a linearly projection of its corresponding image patch. For example, and as described above, image tokenizer 310 of scattering vision transformer 300 is configured to decompose input image 305 into patches with each patch comprising a sub-image of input image 305. Image tokenizer 310 thereafter linearly projects the tensor packages corresponding to each image patch onto a vector thereby generating a plurality of image patch vectors (i.e., patch vectors 335 of FIG. 3).

Flowchart 608 includes step 610. At step 610, each patch vector is augmented to include a positional embedding that corresponds to the position within the input image of its respective image patch. For example, image tokenizer 310 is, as described above, further configured to apply position embedding to each token represented by patch vectors 335 to preserve the spatial information/relationships between and among the image patches.

In the foregoing description of steps 602, 606 and 610 of flowcharts 600, 604 and 606, respectively, it should be understood that at times, such steps may be performed in a different order or even contemporaneously with other steps. Other operational embodiments will be apparent to persons skilled in the relevant art(s). Note also that the foregoing general description of the operation of scattering vision transformer 300 is provided for illustration only, and embodiments of scattering vision transformer 300 may comprise different hardware and/or software, and may operate in manners different than described above.

### III. Example Computer System Implementation

Each of image tokenizer 310, scatter layers 315, attention layers 320, classifier head 325, layer normalization 405, scatter network 410, tensor mixing 415, Einstein mixing 420, inverse scatter network 412, layer normalization 435, multi-layer perceptron 440, layer normalization 505, multi-head self-attention 510, layer normalization 515, and/or multi-layer perceptron 520, and flowcharts 600, 604 and/or 606 may be implemented in hardware, or hardware combined with software and/or firmware. For example, image tokenizer 310, scatter layers 315, attention layers 320, classifier head 325, layer normalization 405, scatter network 410, tensor mixing 415, Einstein mixing 420, inverse scatter network 412, layer normalization 435, multi-layer perceptron 440, layer normalization 505, multi-head self-attention 510, layer normalization 515, and/or multi-layer perceptron 520, and flowcharts 600, 604 and/or 606 may be implemented as computer program code/instructions configured to be executed in one or more processors and stored in a computer readable storage medium. Alternatively, image tokenizer 310, scatter layers 315, attention layers 320, classifier head 325, layer normalization 405, scatter network 410, tensor mixing 415, Einstein mixing 420, inverse scatter network 412, layer normalization 435, multi-layer perceptron 440, layer normalization 505, multi-head self-attention 510, layer normalization 515, and/or multi-layer perceptron 520, and flowcharts 600, 604 and/or 606 may be implemented as hardware logic/electrical circuitry.

For instance, in an embodiment, one or more, in any combination, of image tokenizer 310, scatter layers 315, attention layers 320, classifier head 325, layer normalization 405, scatter network 410, tensor mixing 415, Einstein mixing 420, inverse scatter network 412, layer normalization 435, multi-layer perceptron 440, layer normalization 505, multi-head self-attention 510, layer normalization 515, and/or multi-layer perceptron 520, and flowcharts 600, 604 and/or 606 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

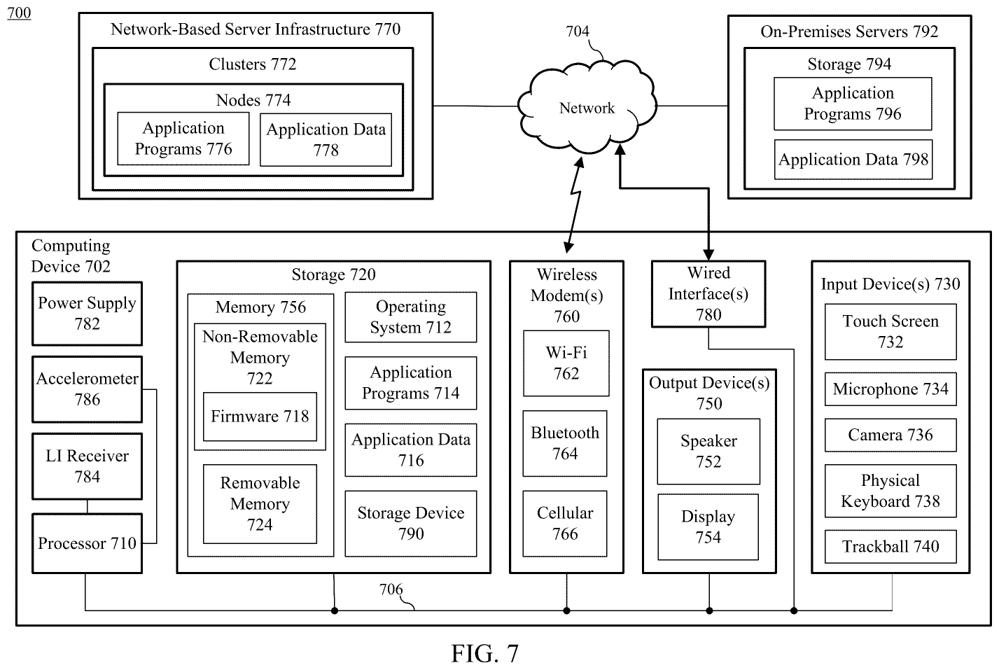

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 7. FIG. 7 shows a block diagram of an exemplary computing environment 700 that includes a computing device 702. Computing device 702 is an example computing device in which embodiments may be implemented. In some embodiments, computing device 702 is communicatively coupled with devices (not shown in FIG. 7) external to computing environment 700 via network 1004. Network 704 is an example of network 106 of FIG. 1. Network 704 comprises one or more networks such as local area networks (LANs), wide area networks (WANs), enterprise networks, the Internet, etc., and may include one or more wired and/or wireless portions. Network 704 may additionally or alternatively include a cellular network for cellular communications. Computing device 1002 is described in detail as follows.

Computing device 702 can be any of a variety of types of computing devices. For example, computing device 702 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 702 may alternatively be a stationary computing device such as a desktop computer, a personal computer (PC), a stationary server device, a minicomputer, a mainframe, a supercomputer, etc.

As shown in FIG. 7, computing device 702 includes a variety of hardware and software components, including a processor 710, a storage 720, one or more input devices 730, one or more output devices 750, one or more wireless modems 760, one or more wired interfaces 780, a power supply 782, a location information (LI) receiver 784, and an accelerometer 786. Storage 720 includes memory 756, which includes non-removable memory 722 and removable memory 724, and a storage device 790. Storage 720 also stores an operating system 712, application programs 714, and application data 716. Wireless modem(s) 760 include a Wi-Fi modem 762, a Bluetooth modem 764, and a cellular modem 766. Output device(s) 750 includes a speaker 752 and a display 754. Input device(s) 730 includes a touch screen 732, a microphone 734, a camera 736, a physical keyboard 738, and a trackball 740. Not all components of computing device 702 shown in FIG. 7 are present in all embodiments, additional components not shown may be present, and any combination of the components may be present in a particular embodiment. These components of computing device 702 are described as follows.

A single processor 710 (e.g., central processing unit (CPU), microcontroller, a microprocessor, signal processor, ASIC (application specific integrated circuit), and/or other physical hardware processor circuit) or multiple processors 710 may be present in computing device 702 for performing such tasks as program execution, signal coding, data processing, input/output processing, power control, and/or other functions. Processor 710 may be a single-core or multi-core processor, and each processor core may be single-threaded or multithreaded (to provide multiple threads of execution concurrently). Processor 710 is configured to execute program code stored in a computer readable medium, such as program code of operating system 712 and application programs 714 stored in storage 720. Operating system 712 controls the allocation and usage of the components of computing device 702 and provides support for one or more application programs 714 (also referred to as “applications” or “apps”). Application programs 714 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 702 can communicate with any other component according to function, although not all connections are shown for ease of illustration. For instance, as shown in FIG. 7, bus 706 is a multiple signal line communication medium (e.g., conductive traces in silicon, metal traces along a motherboard, wires, etc.) that may be present to communicatively couple processor 710 to various other components of computing device 702, although in other embodiments, an alternative bus, further buses, and/or one or more individual signal lines may be present to communicatively couple components. Bus 706 represents one or more of any of several types of bus structures, including a memory bus or memory controller, a peripheral bus, an accelerated graphics port, and a processor or local bus using any of a variety of bus architectures.

Storage 720 is physical storage that includes one or both of memory 756 and storage device 790, which store operating system 712, application programs 714, and application data 716 according to any distribution. Non-removable memory 722 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 722 may include main memory and may be separate from or fabricated in a same integrated circuit as processor 710. As shown in FIG. 7, non-removable memory 722 stores firmware 718, which may be present to provide low-level control of hardware. Examples of firmware 718 include BIOS (Basic Input/Output System, such as on personal computers) and boot firmware (e.g., on smart phones). Removable memory 724 may be inserted into a receptacle of or otherwise coupled to computing device 702 and can be removed by a user from computing device 702. Removable memory 724 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 790 may be present that are internal and/or external to a housing of computing device 702 and may or may not be removable. Examples of storage device 790 include a hard disk drive, a SSD, a thumb drive (e.g., a USB (Universal Serial Bus) flash drive), or other physical storage device.

One or more programs may be stored in storage 720. Such programs include operating system 712, one or more application programs 714, and other program modules and program data. Examples of such application programs may include, for example, computer program logic (e.g., computer program code/instructions) for implementing one or more of image tokenizer 310, scatter layers 315, attention layers 320, classifier head 325, layer normalization 405, scatter network 410, tensor mixing 415, Einstein mixing 420, inverse scatter network 412, layer normalization 435, multi-layer perceptron 440, layer normalization 505, multi-head self-attention 510, layer normalization 515, and/or multi-layer perceptron 520, and flowcharts 600, 604 and/or 606 (including any suitable step of flowcharts 600, 604 and/or 606) described herein, including portions thereof, and/or further examples described herein.

Storage 720 also stores data used and/or generated by operating system 712 and application programs 714 as application data 716. Examples of application data 716 include web pages, text, images, tables, sound files, video data, and other data, which may also be sent to and/or received from one or more network servers or other devices via one or more wired or wireless networks. Storage 720 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 702 through one or more input devices 730 and may receive information from computing device 702 through one or more output devices 750. Input device(s) 730 may include one or more of touch screen 732, microphone 734, camera 736, physical keyboard 738 and/or trackball 740 and output device(s) 750 may include one or more of speaker 752 and display 754. Each of input device(s) 730 and output device(s) 750 may be integral to computing device 702 (e.g., built into a housing of computing device 702) or external to computing device 702 (e.g., communicatively coupled wired or wirelessly to computing device 702 via wired interface(s) 780 and/or wireless modem(s) 760). Further input devices 730 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 754 may display information, as well as operating as touch screen 732 by receiving user commands and/or other information (e.g., by touch, finger gestures, virtual keyboard, etc.) as a user interface. Any number of each type of input device(s) 730 and output device(s) 750 may be present, including multiple microphones 734, multiple cameras 736, multiple speakers 752, and/or multiple displays 754.

One or more wireless modems 760 can be coupled to antenna(s) (not shown) of computing device 702 and can support two-way communications between processor 710 and devices external to computing device 702 through network 704, as would be understood to persons skilled in the relevant art(s). Wireless modem 760 is shown generically and can include a cellular modem 766 for communicating with one or more cellular networks, such as a GSM network for data and voice communications within a single cellular network, between cellular networks, or between the mobile device and a public switched telephone network (PSTN). Wireless modem 760 may also or alternatively include other radio-based modem types, such as a Bluetooth modem 764 (also referred to as a “Bluetooth device”) and/or Wi-Fi 762 modem (also referred to as an “wireless adaptor”). Wi-Fi modem 762 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 764 is configured to communicate with another Bluetooth-capable device according to the Bluetooth short-range wireless technology standard(s) such as IEEE 802.15.1 and/or managed by the Bluetooth Special Interest Group (SIG).

Computing device 702 can further include power supply 782, LI receiver 784, accelerometer 786, and/or one or more wired interfaces 780. Example wired interfaces 780 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 780 of computing device 702 provide for wired connections between computing device 702 and network 704, or between computing device 702 and one or more devices/peripherals when such devices/peripherals are external to computing device 702 (e.g., a pointing device, display 754, speaker 752, camera 736, physical keyboard 738, etc.). Power supply 782 is configured to supply power to each of the components of computing device 702 and may receive power from a battery internal to computing device 702, and/or from a power cord plugged into a power port of computing device 702 (e.g., a USB port, an A/C power port). LI receiver 784 may be used for location determination of computing device 702 and may include a satellite navigation receiver such as a Global Positioning System (GPS) receiver or may include other type of location determiner configured to determine location of computing device 702 based on received information (e.g., using cell tower triangulation, etc.). Accelerometer 786 may be present to determine an orientation of computing device 702.

Note that the illustrated components of computing device 702 are not required or all-inclusive, and fewer or greater numbers of components may be present as would be recognized by one skilled in the art. For example, computing device 702 may also include one or more of a gyroscope, barometer, proximity sensor, ambient light sensor, digital compass, etc. Processor 710 and memory 756 may be co-located in a same semiconductor device package, such as being included together in an integrated circuit chip, FPGA, or system-on-chip (SOC), optionally along with further components of computing device 702.

In embodiments, computing device 702 is configured to implement any of the above-described features of flowcharts herein. Computer program logic for performing any of the operations, steps, and/or functions described herein may be stored in storage 720 and executed by processor 710.

In some embodiments, server infrastructure 770 may be present in computing environment 700 and may be communicatively coupled with computing device 702 via network 704. Server infrastructure 770, when present, may be a network-accessible server set (e.g., a cloud-based environment or platform). As shown in FIG. 7, server infrastructure 770 includes clusters 772. Each of clusters 772 may comprise a group of one or more compute nodes and/or a group of one or more storage nodes. For example, as shown in FIG. 7, cluster 772 includes nodes 774. Each of nodes 774 are accessible via network 704 (e.g., in a “cloud-based” embodiment) to build, deploy, and manage applications and services. Any of nodes 774 may be a storage node that comprises a plurality of physical storage disks, SSDs, and/or other physical storage devices that are accessible via network 704 and are configured to store data associated with the applications and services managed by nodes 774. For example, as shown in FIG. 7, nodes 774 may store application data 778.

Each of nodes 774 may, as a compute node, comprise one or more server computers, server systems, and/or computing devices. For instance, a node 774 may include one or more of the components of computing device 702 disclosed herein. Each of nodes 774 may be configured to execute one or more software applications (or “applications”) and/or services and/or manage hardware resources (e.g., processors, memory, etc.), which may be utilized by users (e.g., customers) of the network-accessible server set. For example, as shown in FIG. 7, nodes 774 may operate application programs 776. In an implementation, a node of nodes 774 may operate or comprise one or more virtual machines, with each virtual machine emulating a system architecture (e.g., an operating system), in an isolated manner, upon which applications such as application programs 776 may be executed.

In an embodiment, one or more of clusters 772 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 772 may be a datacenter in a distributed collection of datacenters. In embodiments, exemplary computing environment 700 comprises part of a cloud-based platform such as Amazon Web Services® of Amazon Web Services, Inc., or Google Cloud Platform™ of Google LLC, although these are only examples and are not intended to be limiting.

In an embodiment, computing device 702 may access application programs 776 for execution in any manner, such as by a client application and/or a browser at computing device 702. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 702 may additionally and/or alternatively synchronize copies of application programs 714 and/or application data 716 to be stored at network-based server infrastructure 770 as application programs 776 and/or application data 778. For instance, operating system 712 and/or application programs 714 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 720 at network-based server infrastructure 770.

In some embodiments, on-premises servers 792 may be present in computing environment 700 and may be communicatively coupled with computing device 702 via network 704. On-premises servers 792, when present, are hosted within an organization's infrastructure and, in many cases, physically onsite of a facility of that organization. On-premises servers 792 are controlled, administered, and maintained by IT (Information Technology) personnel of the organization or an IT partner to the organization. Application data 798 may be shared by on-premises servers 792 between computing devices of the organization, including computing device 702 (when part of an organization) through a local network of the organization, and/or through further networks accessible to the organization (including the Internet). Furthermore, on-premises servers 792 may serve applications such as application programs 796 to the computing devices of the organization, including computing device 702. Accordingly, on-premises servers 792 may include storage 794 (which includes one or more physical storage devices such as storage disks and/or SSDs) for storage of application programs 796 and application data 798 and may include one or more processors for execution of application programs 796. Still further, computing device 702 may be configured to synchronize copies of application programs 714 and/or application data 716 for backup storage at on-premises servers 792 as application programs 796 and/or application data 798.

Embodiments described herein may be implemented in one or more of computing device 702, network-based server infrastructure 770, and on-premises servers 792. For example, in some embodiments, computing device 702 may be used to implement systems, clients, or devices, or components/subcomponents thereof, disclosed elsewhere herein. In other embodiments, a combination of computing device 702, network-based server infrastructure 770, and/or on-premises servers 792 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk. SSD, other physical hardware media such as RAMs, ROMs, flash memory, digital video disks, zip disks, MEMs (microelectronic machine) memory, nanotechnology-based storage devices, and further types of physical/tangible hardware storage media of storage 720. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 714) may be stored in storage 720. Such computer programs may also be received via wired interface(s) 780 and/or wireless modem(s) 760 over network 704. Such computer programs, when executed or loaded by an application, enable computing device 702 to implement features of embodiments described herein. Accordingly, such computer programs represent controllers of the computing device 702.

Embodiments are also directed to computer program products comprising computer code or instructions stored on any computer-readable medium or computer-readable storage medium. Such computer program products include the physical storage of storage 720 as well as further physical storage types.

### IV. Additional Example Embodiments

A method for generating an image classification of an input image is provided herein. In an embodiment, the method comprises: providing a plurality of image patch vectors corresponding to the input image to a sequence of neural network layers configured to generate the image classification, wherein the sequence of neural network layers comprises: at least one scatter layer configured to receive the plurality of image patch vectors and to process the plurality of image patch vectors to generate a first scatter output; at least one attention layer configured to receive the first scatter output and to process the first scatter output to generate an attention output; and a classifier head layer configured to receive the attention output and to process the first scatter output to generate the classification of the input image.

In another embodiment of the foregoing method, the method further comprises generating a plurality of image patches from the input image, wherein each image patch vector of the plurality of image patch vectors corresponds to one of the plurality of image patches and comprises a linearly projection of its corresponding image patch.

In another embodiment of the foregoing method, the method further comprises augmenting each patch vector to include a positional embedding that corresponds to the position within the input image of its respective image patch.

In another embodiment of the foregoing method, the at least one scatter layer comprises: a scatter network layer configured to receive the plurality of image patch vectors and to generate low-frequency tokens and high-frequency tokens by applying a dual-tree complex wavelet transform; a token mixing layer configured to mix the low-frequency tokens with a first set of trainable weights to generate a low-frequency representation, and to mix the high-frequency tokens with a second set of trainable weights to generate a high-frequency representation; an inverse scatter network layer configured to combine the low-frequency representation and the high-frequency representation by applying an inverse dual-tree complex wavelet transform to generate a combined output; and a multi-layer perceptron layer configured to receive the combined output and process the combined output to generate the first scatter output.

In another embodiment of the foregoing method, the token mixing layer is configured to mix the low frequency tokens with the first set of trainable weights by performing tensor mixing.

In another embodiment of the foregoing method, the token mixing layer is configured to mix the high frequency tokens with the second set of trainable weights by performing Einstein mixing.

In another embodiment of the foregoing method, the at least one attention layer comprises a multi-headed self-attention sublayer coupled to a multi-layer perceptron sublayer.

In another embodiment of the foregoing method, the multi-headed self-attention sublayer and the multi-layer perceptron sublayer each further include layer normalization sublayers.

An image classification system implemented by one or more computers, is provided herein wherein the image classification system is configured to receive an input image and generate an image classification for the input image. In an embodiment, the image classification system comprises a sequence of neural network layers, comprising: at least one scatter layer configured to receive a plurality of image patch vectors corresponding to the input image and to process the plurality of image patch vectors to generate a first scatter output; at least one attention layer configured to receive the first scatter output and to process the first scatter output to generate an attention output; and a classifier head layer configured to receive the attention output and to process the first scatter output to generate the image classification of the input image.

In an embodiment of the foregoing image classification system, each image patch vector of the plurality of patch vectors corresponds to one of a plurality of image patches generated from the input image, wherein each image patch vector comprises a linear projection of its corresponding image patch.

In an embodiment of the foregoing image classification system, each patch vector is augmented to include a positional embedding that corresponds to the position within the input image of its respective image patch.

In an embodiment of the foregoing image classification system, the at least one scatter layer comprises: a scatter network layer configured to receive the plurality of image patch vectors and to generate low-frequency tokens and high-frequency tokens by applying a dual-tree complex wavelet transform; a token mixing layer configured to mix the low-frequency tokens with a first set of trainable weights to generate a low-frequency representation, and to mix the high-frequency tokens with a second set of trainable weights to generate a high-frequency representation; an inverse scatter network layer configured to combine the low-frequency representation and the high-frequency representation by applying an inverse dual-tree complex wavelet transform to generate a combined output; and a multi-layer perceptron layer configured to receive the combined output and process the combined output to generate the first scatter output.

In an embodiment of the foregoing image classification system, the token mixing layer is configured to mix the low frequency tokens with the first set of trainable weights by performing tensor mixing.

In an embodiment of the foregoing image classification system, the token mixing layer is configured to mix the high frequency tokens with the second set of trainable weights by performing Einstein mixing.

In an embodiment of the foregoing image classification system, the at least one attention layer comprises a multi-headed self-attention sublayer coupled to a multi-layer perceptron sublayer.

In an embodiment of the foregoing image classification system, the multi-headed self-attention sublayer and the multi-layer perceptron sublayer each further include layer normalization sublayers.

One or more non-transitory computer readable media encoded with a computer program comprising instructions that when executed by the one or more computers cause the one or more computers to perform operations for generating an image classification of an input image using a sequence of neural network layers is provided herein. In an embodiment, the operations comprise: providing a plurality of image patch vectors corresponding to the input image to the sequence of neural network layers configured to generate the image classification, wherein the sequence of neural network layers comprises: at least one scatter layer configured to receive the plurality of image patch vectors and to process the plurality of image patch vectors to generate a first scatter output; at least one attention layer configured to receive the first scatter output and to process the first scatter output to generate an attention output; and a classifier head layer configured to receive the attention output and to process the first scatter output to generate the classification of the input image.

In an embodiment of the one or more non-transitory computer readable media, the at least one scatter layer comprises: a scatter network layer configured to receive the plurality of image patch vectors and to generate low-frequency tokens and high-frequency tokens by applying a dual-tree complex wavelet transform; a token mixing layer configured to mix the low-frequency tokens with a first set of trainable weights to generate a low-frequency representation, and to mix the high-frequency tokens with a second set of trainable weights to generate a high-frequency representation; an inverse scatter network layer configured to combine the low-frequency representation and the high-frequency representation by applying an inverse dual-tree complex wavelet transform to generate a combined output; and a multi-layer perceptron layer configured to receive the combined output and process the combined output to generate the first scatter output.

In an embodiment of the one or more non-transitory computer readable media the token mixing layer is configured to mix the low frequency tokens with the first set of trainable weights by performing tensor mixing.

In an embodiment of the one or more non-transitory computer readable media the token mixing layer is configured to mix the high frequency tokens with the second set of trainable weights by performing Einstein mixing.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the description, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (e.g., or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (e.g., computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A method for generating an image classification of an input image, the method comprising:
providing a plurality of image patch vectors corresponding to the input image to a sequence of neural network layers configured to generate the image classification, wherein the sequence of neural network layers comprises:
at least one scatter layer configured to receive the plurality of image patch vectors and to process the plurality of image patch vectors to generate a first scatter output;
at least one attention layer configured to receive the first scatter output and to process the first scatter output to generate an attention output; and
a classifier head layer configured to receive the attention output and to process the first scatter output to generate the classification of the input image.

2. The method of claim 1, further comprising:
generating a plurality of image patches from the input image, wherein each image patch vector of the plurality of image patch vectors corresponds to one of the plurality of image patches and comprises a linearly projection of its corresponding image patch.

3. The method of claim 2, further comprising:
augmenting each patch vector to include a positional embedding that corresponds to the position within the input image of its respective image patch.

4. The method of claim 3, wherein the at least one scatter layer comprises:
a scatter network layer configured to receive the plurality of image patch vectors and to generate low-frequency tokens and high-frequency tokens by applying a dual-tree complex wavelet transform;
a token mixing layer configured to mix the low-frequency tokens with a first set of trainable weights to generate a low-frequency representation, and to mix the high-frequency tokens with a second set of trainable weights to generate a high-frequency representation;
an inverse scatter network layer configured to combine the low-frequency representation and the high-frequency representation by applying an inverse dual-tree complex wavelet transform to generate a combined output; and
a multi-layer perceptron layer configured to receive the combined output and process the combined output to generate the first scatter output.

5. The method of claim 4, wherein the token mixing layer is configured to mix the low frequency tokens with the first set of trainable weights by performing tensor mixing.

6. The method of claim 4, wherein the token mixing layer is configured to mix the high frequency tokens with the second set of trainable weights by performing Einstein mixing.

7. The method of claim 1, wherein the at least one attention layer comprises a multi-headed self-attention sublayer coupled to a multi-layer perceptron sublayer.

8. The method of claim 7, wherein the multi-headed self-attention sublayer and the multi-layer perceptron sublayer each further include layer normalization sublayers.

9. An image classification system implemented by one or more computers, wherein the image classification system is configured to receive an input image and generate an image classification for the input image, the image classification system comprising:
a sequence of neural network layers, comprising:
at least one scatter layer configured to receive a plurality of image patch vectors corresponding to the input image and to process the plurality of image patch vectors to generate a first scatter output;
at least one attention layer configured to receive the first scatter output and to process the first scatter output to generate an attention output; and
a classifier head layer configured to receive the attention output and to process the first scatter output to generate the image classification of the input image.

10. The image classification system of claim 9, wherein each image patch vector of the plurality of patch vectors corresponds to one of a plurality of image patches generated from the input image, wherein each image patch vector comprises a linear projection of its corresponding image patch.

11. The image classification system of claim 10, wherein each patch vector is augmented to include a positional embedding that corresponds to the position within the input image of its respective image patch.

12. The image classification system of claim 11, wherein the at least one scatter layer comprises:
a scatter network layer configured to receive the plurality of image patch vectors and to generate low-frequency tokens and high-frequency tokens by applying a dual-tree complex wavelet transform;
a token mixing layer configured to mix the low-frequency tokens with a first set of trainable weights to generate a low-frequency representation, and to mix the high-frequency tokens with a second set of trainable weights to generate a high-frequency representation;
an inverse scatter network layer configured to combine the low-frequency representation and the high-frequency representation by applying an inverse dual-tree complex wavelet transform to generate a combined output; and
a multi-layer perceptron layer configured to receive the combined output and process the combined output to generate the first scatter output.

13. The image classification system of claim 12, wherein the token mixing layer is configured to mix the low frequency tokens with the first set of trainable weights by performing tensor mixing.

14. The image classification system of claim 12, wherein the token mixing layer is configured to mix the high frequency tokens with the second set of trainable weights by performing Einstein mixing.

15. The image classification system of claim 9, wherein the at least one attention layer comprises a multi-headed self-attention sublayer coupled to a multi-layer perceptron sublayer.

16. The image classification system of claim 15, wherein the multi-headed self-attention sublayer and the multi-layer perceptron sublayer each further include layer normalization sublayers.

17. One or more non-transitory computer readable media encoded with a computer program comprising instructions that when executed by the one or more computers cause the one or more computers to perform operations for generating an image classification of an input image using a sequence of neural network layers, the operations comprising:
providing a plurality of image patch vectors corresponding to the input image to the sequence of neural network layers configured to generate the image classification, wherein the sequence of neural network layers comprises:
at least one scatter layer configured to receive the plurality of image patch vectors and to process the plurality of image patch vectors to generate a first scatter output;
at least one attention layer configured to receive the first scatter output and to process the first scatter output to generate an attention output; and
a classifier head layer configured to receive the attention output and to process the first scatter output to generate the classification of the input image.

18. The one or more non-transitory computer readable media of claim 17, wherein the at least one scatter layer comprises:
a scatter network layer configured to receive the plurality of image patch vectors and to generate low-frequency tokens and high-frequency tokens by applying a dual-tree complex wavelet transform;
a token mixing layer configured to mix the low-frequency tokens with a first set of trainable weights to generate a low-frequency representation, and to mix the high-frequency tokens with a second set of trainable weights to generate a high-frequency representation;
an inverse scatter network layer configured to combine the low-frequency representation and the high-frequency representation by applying an inverse dual-tree complex wavelet transform to generate a combined output; and
a multi-layer perceptron layer configured to receive the combined output and process the combined output to generate the first scatter output.

19. The one or more non-transitory computer readable media of claim 18, wherein the token mixing layer is configured to mix the low frequency tokens with the first set of trainable weights by performing tensor mixing.

20. The one or more non-transitory computer readable media of claim 19, wherein the token mixing layer is configured to mix the high frequency tokens with the second set of trainable weights by performing Einstein mixing.
